(19) United States
(12) Patent Application Publication
(10) Pub. No.: US 2026/0016085 A1
(43) Pub. Date: Jan. 15, 2026

(54) PLANET CARRIER

(71) Applicant: AKTIEBOLAGET SKF, GOTEBORG (SE)

(72) Inventors: Ingo SCHULZ, Gerolzhofen (DE); Daniel RECK, Würzburg (DE)

(21) Appl. No.: 18/881,942

(22) PCT Filed: Jul. 5, 2023
(86) PCT No.: PCT/EP2023/068488

§ 371 Date: Jan. 7, 2025

(30) Foreign Application Priority Data
Jul. 20, 2022 (DE) 10 2022 207 421.1

(51) Int. Cl. F16H 57/08; F16H 57/04

(52) U.S. Cl. CPC F16H 57/082; F16H 57/043; F16H 57/0471; F16H 57/0479; F16H 57/0482; F16H 2057/085

(57) ABSTRACT

A planet carrier includes a cylindrical disc-shaped body having a cylindrical outer surface and a cylindrical inner surface, the cylindrical inner surface defining a central inner bore, and a plurality of outer bores at locations radially between the inner bore and the outer surface. Each of the outer bores is configured to receive a planet bearing or to form an outer ring of a planet bearing. Also, at least one inner lubricating passage extends from the cylindrical inner surface to each of the outer bores, and/or at least one outer lubricating passage extends from the outer cylindrical surface to each of the outer bores.

The present invention relates to a planetary carrier according to the preamble of Patent claim 1.

Planetary bearings are used in planetary transmissions, in particular precision transmissions, to mount the planets in a planetary carrier. Planetary bearings of this type have to be lubricated sufficiently, in order to operate correctly and to achieve a sufficient service life. On account of the compactness of planetary transmissions of this type, both the integration of a lubricant supply and the integration of an apparatus to transport the lubricant into the planetary transmission are a challenge.

Up to now, planetary bearings have been lubricated by lubricant being introduced into the planetary transmission by immersion lubrication. It is relied upon here that a sufficient quantity of lubricant passes to the planetary bearings and, in particular, the running surfaces during the immersion lubrication as a result of the rotation of the planetary carrier.

It is therefore an object of the present invention to provide a planetary carrier which makes sustained and reliable lubrication of the planetary bearings possible.

This object is achieved by a planetary carrier according to Patent claim 1.

The planetary carrier has a cylindrical disc shape with an outer and an inner shell surface. Here, the inner shell surface defines a central inner bore, in which a sun gear of a planetary transmission can be arranged. Furthermore, a plurality of outer bores which are arranged around the central inner bore are provided in the disc. Planetary gears can be mounted in the outer bore, in particular with use of planetary bearings which are received in the outer bores.

In order then to achieve reliable and sustained lubrication in comparison with previous planetary transmissions, a lubricating passage is provided at least in sections on the inner shell surface. This lubricating passage can be configured as a lubricating groove which runs around completely or in sections. As an alternative, the lubricating passage can be configured as a lubricating duct (or a plurality of lubricating ducts) from the central inner bore to the outer bores. For example, the lubricating passage can be produced as a groove in sections, and not in a completely circumferential manner, for example by way of a side milling cutter or the like, wherein the inner shell surface is pierced only at the position of the outer bore. The depth of this piercing reaches here as far as the respective outer bore and therefore forms the lubricating passage. Further embodiments are likewise possible, wherein some variants are explained in greater detail below. In every case, the lubricating passage is configured to forward lubricant which is introduced into the inner bore to the outer bores and therefore to the planetary bearings. This can take place during operation, with the result that sustained lubrication of the planetary bearings is made possible in contrast with immersion lubrication.

As an alternative or in addition, a lubricating passage can also be provided, at least in sections, on the outer shell surface. A lubricating passage of this type is configured to forward lubricant from the outer side of the planetary carrier to the outer bores. Just like the lubricating passage on the outer shell surface, this lubricating passage can be configured as a lubricating groove which is circumferential completely or in sections. As an alternative, the lubricating passage can be configured as a lubricating duct (or a plurality of lubricating ducts) from the outer side, that is to say from the outer shell surface, to the outer bores. Further embodiments are likewise possible, wherein some variants are explained in greater detail below.

In accordance with one embodiment, a plurality of lubricating passages which are distributed circumferentially can be provided on or in the inner shell surface. A circumferential distribution of this type can ensure that lubricant passes to all outer bores.

The depth of the one or the plurality of lubricating passages can preferably extend at least partially radially outwards as far as the outer bores. In this way, the lubricant can be conveyed from the central inner bore via the lubricating passage/passages to the planetary bearings, that is to say to the outer bores. This means that a lubricant passage from the central inner bore to the outer bores is formed by this extent of the lubricating passage/passages. In particular, the one or the plurality of lubricating passages is/are formed in this case by through bores from the central inner bore to the outer bores.

In accordance with a further embodiment, the lubricating passage on the inner shell surface comprises a lubricating groove which is arranged on the inner shell surface in the circumferential direction. In addition, the lubricating passage comprises at least one channel which extends radially outwards as far as the outer bores, in order to form a lubricant passage from the central inner bore to the outer bores. The channel is therefore configured as a passage for lubricant from the lubricating groove as far as the outer bores. In this case, lubricant can be introduced into the central inner bore and is then present in the lubricating groove. Starting from the lubricating groove, the lubricant can be conveyed via one or a plurality of channels to the outer bores. The channels are preferably arranged in the region of the outer bores or lead in the radial direction from the inner bore to the outer bores.

Lubricant can pass from the inner bore to the planetary bearings, in particular to their raceways, by way of the lubricant passages which are formed either on account of the radial extent of the depth of the lubricating passage/passages and/or on account of the channels. On account of the force of gravity and/or preferably on account of the centrifugal force during the rotation of the planetary carrier, lubricant is conveyed from the inner bore into the lubricating passage and into the lubricant passages. In particular, as a result of the centrifugal force which arises as a result of rotation of the planetary carrier, lubricant which enters the inner bore of the planetary carrier is accelerated outwards in the radial direction and is pressed into the lubricating passage and the passages to the outer bores.

This is particularly preferably a planetary carrier which rotates with a rotational velocity of more than 30 rpm, preferably approximately 200 rpm. A velocity of this type can ensure that lubricant moves to the outer bores during operation as a result of the centrifugal force. In this way, reliable and sustained lubrication can also be achieved in operation.

As has already been described above, the lubricating passage can be configured as a lubricating groove and, in particular, as a completely circumferential lubricating groove. This makes particularly simple production of the lubricating groove possible, since this can be made, for example milled, in a circumferential manner in the inner shell surface.

In accordance with a further embodiment, the outer bores are configured as outer rings for the planetary bearings. In this case, the outer bores serve directly as outer rings, without additional outer rings being required. The rolling bodies of the planetary bearings can roll on the surface of the outer bores which serve as running surface, or the surface of the outer bores serves as counter-surface for a plain bearing.

As an alternative, outer rings can be inserted into the outer bores. In this case, the outer rings each have a lubricant passage which is connected fluidically to the lubricating passage, for example the channels.

In accordance with a further embodiment, the planetary carrier has, on the outer shell surface, a plurality of lubricating passages which are distributed circumferentially in sections. As a result of these lubricating passages, not only is the inner bore connected fluidically to the outer bores, but rather the outer side can also be connected fluidically to the outer bores. For example, an inner ring of a main bearing which serves to mount the planetary carrier can be arranged on the outer shell surface. This main bearing can be lubricated via these lubricating passages in a similar way as is described for the planetary bearings. As has already been described above for the inner shell surface, this plurality of circumferentially distributed lubricating passages can achieve a situation where lubricant is conveyed particularly satisfactorily to all outer bores.

In accordance with one embodiment, the depth of the one or the plurality of lubricating passages on the outer shell surface can extend at least partially radially inwards as far as the outer bores, in order to form a lubricant passage from the outer side to the outer bores.

As has already also been described for the inner shell surface, the lubricating passage on the outer shell surface can have, in an analogous way, a lubricating groove, which is configured on the outer shell surface in the circumferential direction, and at least one channel which extends radially inwards as far as the outer bores, in order to form a lubricant passage from the outer side to the outer bores. A plurality of channels are preferably provided which are each arranged in the region of the outer bores. In this way, each outer bore can be supplied via a channel with lubricant.

Just like the lubricating passage in the inner shell surface, the lubricating passage in the outer shell surface can also be of circumferential configuration either in sections, in particular in the region from channels to the outer bores, or completely. A circumferential lubricating passage or lubricating groove of this type can be manufactured particularly simply.

Further advantages and advantageous embodiments are specified in the description, the drawings and the claims. Here, in particular, the combinations of the features which are specified in the description and in the drawings are purely by way of example, with the result that the features can also be present individually or in another combination.

In the following text, the invention is to be described in greater detail on the basis of exemplary embodiments which are shown in the drawings. Here, the exemplary embodiments and the combinations which are shown in the exemplary embodiments are purely by way of example and are not intended to define the scope of protection of the invention. This is defined solely by the appended claims.

In the drawings:

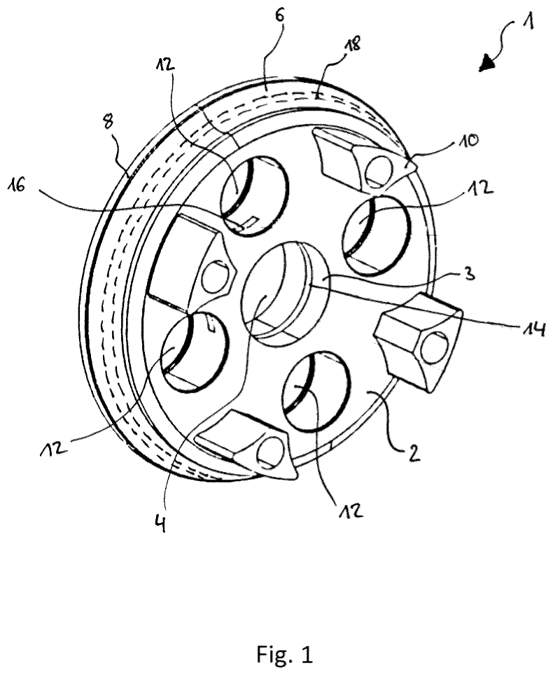

FIG. 1 shows a perspective view of a planetary carrier in accordance with one embodiment, and

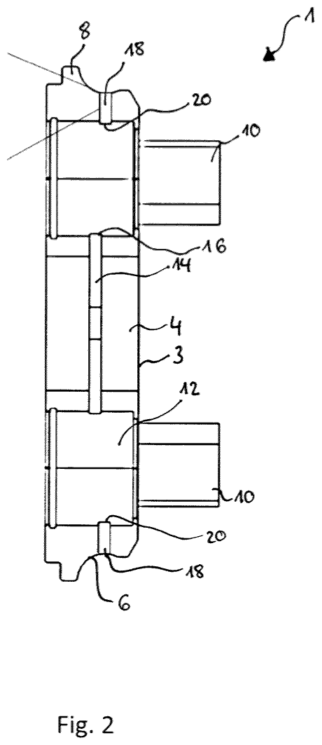

FIG. 2 shows a sectional view of the planetary carrier from FIG. 1.

In the following text, identical or functionally identical acting elements are characterized by the same reference numerals.

FIGS. 1 and 2 show a planetary carrier 1 which comprises a cylindrical disc 2. The disc 2 has an inner shell surface 3 which defines a central inner bore 4. A sun gear (not shown) of a planetary transmission can be arranged in the inner bore 4. Furthermore, the disc 2 has an outer shell surface 6 which can be connected via a main bearing (not shown), for example, to a housing. In the embodiment shown here, a flange 8 is provided on the outer shell surface 6. The flange can be used firstly to attach a drive, for example a further gear stage or an electric drive motor, or to attach the output, for example a further gear stage or a robot arm.

On the end side, the disc has optional rigidity elements 10, via which two planetary carriers can be connected.

Outer bores 12 are arranged around the inner bore 4. Four outer bores 12 are shown here by way of example, but more or fewer outer bores 12 can also be provided. Planetary gears (not shown) can be received in the outer bores 12. To this end, planetary bearings (not shown) which mount the planetary gears in the planetary carrier 1 can be arranged in the outer bores 12. Here, outer rings of the planetary bearings can be received in the outer bores 12, or the outer bores 12 can serve themselves as outer rings.

In order then to enable reliable and sustained lubrication of the planetary bearings in comparison with previous planetary carriers or planetary transmissions, lubricating passages 14, 18 are provided in the planetary carrier 1. One lubricating passage 14 is arranged on the inner shell surface 3, and a further lubricating passage 18 is provided on the outer shell surface 6.

In the following text, one embodiment is described, in which the lubricating passages 14, 18 are each configured as lubricating grooves 14, 18 in combination with channels. It should be noted, however, that different configurations of the lubricating passages 14, 18 are possible. For example, they can also be configured as through bores between the inner bore 4 and the outer bores 12 or the outer side and the outer bores 12. In every case, fluidic connections are produced between the inner bore 4 and the outer bores 12 or the outer side and the outer bores 12 by way of the lubricating passages 14, 18, as will be explained in greater detail in the following text on the basis of one specific embodiment. Furthermore, it is also possible for lubricating passages to be provided only in the inner shell surface or only in the outer shell surface.

In the embodiment which is shown in FIGS. 1 and 2, a lubricating groove 14, as part of a lubricating passage, is provided at least partially in the circumferential direction on the inner shell surface 3. In the embodiment which is shown, the lubricating groove 14 is provided in a completely circumferential manner. It can also be present only in sections, however.

Via this lubricating groove, 14, lubricant which is introduced into the inner bore 4 can be forwarded to the outer bores 12 and therefore to the planetary bearings. During operation, that is to say during a rotation of the planetary carrier 1, lubricant which is situated in the inner bore 4 is pressed outwards and into the lubricating groove 14 by way of the gravitational and/or centrifugal force.

In order then for the lubricant to be conveyed from the lubricating groove 14 further to the planetary bearings, that is to say to the outer bores 12, the depth of the lubricating groove 14 can extend at least partially radially outwards as far as the outer bores 12. In particular in the region of the outer bores 12, the lubricating groove 14 can extend as far as the outer bores 12 or channels can be provided, with the result that the outer bores 12 are connected fluidically to the lubricating groove 14. As can be seen in FIGS. 1 and 2, corresponding passages 16 are present in the outer bores 12, which passages result either from the corresponding depth of the lubricating groove 14 or from channels between the lubricating groove 14 and the outer bores 12.

As has already been explained above, the lubricant is pressed by way of the gravitational and/or centrifugal force into the lubricating groove 14 and subsequently from the lubricating groove 14 into the passages 16 and then into the planetary bearings. If outer rings are received in the outer bores 12, they can likewise have lubricant passages, for example channels, in order to convey the lubricant into the interior space of the planetary bearing and, in particular, onto the running surfaces.

As is shown in FIGS. 1 and 2, a further lubricating groove 18 can additionally be provided in the outer shell surface 6 in the circumferential direction. By way of this further lubricating groove 18, not only is the inner bore 4 connected fluidically to the outer bores 12, but rather also the outer side can be connected fluidically to the outer bores 12.

In addition to the passages 16 for fluidic connection to the inner bore 4, the outer bores 12 can have further passages or channels 20, as shown in FIG. 2. Via these channels 20, the outer bores 12 are connected fluidically to the lubricating groove 18 in the outer shell surface 6 and therefore to the outer side. In this way, lubricant which is present via the inner bore 4 or in the inner bore 4 can be transported not only to the outer bores 12 but rather also to the outer shell surface 6 and, for example, to a main bearing which is arranged there. Just like the planetary bearings, a main bearing of this type might have corresponding passages, in order to transport the lubricant into the interior space of the main bearing.

In summary, the planetary carrier described herein achieves simple and reliable lubrication of the planetary bearings which can be maintained sustainably, that is to say also and precisely in operation of the planetary carrier.

### LIST OF REFERENCE NUMERALS

1 Planetary carrier
2 Disc
3 Inner shell surface
4 Inner bore
6 Outer shell surface
8 Flange
10 Rigidity element
12 Outer bore
14 Lubricating groove
16 Passage
18 Lubricating groove
20 Passage

1-10. (canceled)

11. A planet carrier comprising:
a cylindrical disc-shaped body having a cylindrical outer surface and a cylindrical inner surface, the cylindrical inner surface defining a central inner bore, and a plurality of outer bores at locations radially between the inner bore and the outer surface, each of the outer bores being configured to receive a planet bearing or to form an outer ring of a planet bearing,
wherein at least one inner lubricating passage extends from the cylindrical inner surface to each of the outer bores, and/or
wherein at least one outer lubricating passage extends from the outer cylindrical surface to each of the outer bores.

12. The planet carrier according to claim 11,
wherein the planet carrier includes the at least one inner lubricating passage,
wherein the cylindrical inner surface includes at least one circumferentially extending inner lubricating groove, and
wherein each of the at least one inner lubricating passage includes a lubricating channel having a first end at the inner lubricating groove and a second end at one of the outer bores.

13. The planet carrier according to claim 12,
including the planet bearing in each of the outer bores.

14. The planet carrier according to claim 12,
wherein the outer bores are configured to form the outer rings of the planet bearings.

15. The planet carrier according to claim 11,
wherein the planet carrier includes the at least one inner lubricating passage, and
wherein the at least one inner lubricating passage comprises a circumferentially extending inner lubricating channel formed in the cylindrical inner surface and intersecting the outer bores.

16. The planet carrier according to claim 11,
wherein the planet carrier includes the at least one outer lubricating passage,
wherein the cylindrical outer surface includes at least one circumferentially extending outer lubricating groove, and
wherein each of the at least one outer lubricating passage includes an outer lubricating channel having a first end at the at least one outer lubricating groove and a second end at one of the outer bores.

17. The planet carrier according to claim 16,
including the planet bearing in each of the outer bores.

18. The planet carrier according to claim 16,
wherein the outer bores are configured to form the outer rings of the planet bearings.

19. The planet carrier according to claim 11,
wherein the planet carrier includes the at least one outer lubricating passage, and
wherein the at least one outer lubricating passage comprises a circumferentially extending outer lubricating channel formed in the cylindrical outer surface and intersecting the outer bores.

20. The planet carrier according to claim 11,
wherein the planet carrier includes the at least one inner lubricating passage and the at least one outer lubricating passage,
wherein the cylindrical inner surface includes at least one circumferentially extending inner lubricating groove and the cylindrical outer surface includes at least one circumferentially extending outer lubricating groove, and
wherein each of the at least one inner lubricating passage includes an inner lubricating channel having a first end at the at least one inner lubricating groove and a second end at one of the outer bores and each of the at least one outer lubricating passage includes an outer lubricating channel having a first end at the at least one outer lubricating groove and a second end at one of the outer bores.

21. The planet carrier according to claim 20,
including the planet bearing in each of the outer bores.

22. The planet carrier according to claim 20,
wherein the outer bores are configured to form the outer rings of the planet bearings.

23. The planet carrier according to claim 11,
wherein the planet carrier includes the at least one inner lubricating passage and the at least one outer lubricating passage,
wherein the at least one inner lubricating passage comprises a circumferentially extending inner lubricating channel formed in the cylindrical inner surface an intersecting the outer bores, and
wherein the at least one outer lubricating passage comprises a circumferentially extending outer lubricating channel formed in the cylindrical outer surface and intersecting the outer bores.
